(19) United States
(12) Patent Application Publication
(10) Pub. No.: US 2023/0026327 A1
(43) Pub. Date: Jan. 26, 2023

(54) SIDELINK TRANSMISSION METHOD AND APPARATUS

(71) Applicant: FUJITSU LIMITED, Kawasaki-shi (JP)

(72) Inventors: Guorong LI, Beijing (CN); Pengyu JI, Beijing (CN); Meiyi JIA, Beijing (CN); Xin WANG, Beijing (CN)

(73) Assignee: FUJITSU LIMITED, Kawasaki-shi (JP)

(21) Appl. No.: 17/956,094

(22) Filed: Sep. 29, 2022

Related U.S. Application Data
(63) Continuation of application No. PCT/CN2020/084064, filed on Apr. 9, 2020.

(51) Int. Cl. H04L 5/00; H04L 1/18

(52) U.S. Cl. CPC H04L 5/0055; H04L 1/1812; H04W 92/18

(57) ABSTRACT

A sidelink transmission method and apparatus. The method includes: receiving sidelink control information by a terminal equipment at a physical layer (PHY), the sidelink control information being used to trigger report of sidelink channel state information; generating sidelink channel state information by the terminal equipment at the physical layer; and transmitting the sidelink control information and the sidelink channel state information by the terminal equipment from the physical layer to a media access control (MAC) layer. Hence, a valid CSI measurement result may be transmitted, and waste of sidelink resources may be avoided at the same time.

### CROSS-REFERENCE TO RELATED APPLICATION

This application is a continuation application of International Application PCT/CN2020/084064 filed on Apr. 9, 2020, and designated the U.S., the entire contents of which are incorporated herein by reference.

### TECHNICAL FIELD

This disclosure relates to the field of communication technologies.

### BACKGROUND

Vehicle communication services are denoted by V2X (Vehicle-to-everything) services. V2X services may include multiple types, such as Vehicle-to-Vehicle (V2V) communication services, Vehicle-to-Infrastructure (V21) communication services, and Vehicle-to-Pedestrian (V2P) communication services, etc. V2X services may be provided via a PC5 interface and/or a Uu interface. V2X services transmitted via a PC5 interface may be provided by V2X sidelink (SL) communication. The V2X sidelink communication is a communication mode in which terminal equipments may directly communicate with each other via a PC5 interface. In long term evolution (LTE) or new radio (NR), such a communication mode is support no matter the terminal equipments are within or outside the coverage of the network.

V2X has two resource allocation modes, mode 1 and mode 2. Mode 1 refers to a resource allocation mode where a network device schedules sidelink resources, and mode 2 refers to a resource allocation mode where a terminal equipment autonomously selects resources.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

It was found by the inventors that when a transmitting terminal equipment has a sidelink media access control control element (MAC CE) to be transmitted, such as carrying information in the MAC CE, such as channel state information (CSI), due to delay of information acquisition, it may occur that sidelink resources for new transmission arrive before the information is obtained. At this moment, the information may not be transmitted in the sidelink resources, which will lead to waste of sidelink resources.

It was further found by the inventors that when the transmitting terminal equipment has a sidelink media access control control element (MAC CE) and a sidelink logical channel (LCH) to be transmitted and the sidelink MAC CE and the sidelink LCH have identical priorities, it is not specified which destination terminal equipment the transmitting terminal equipment selects to perform corresponding sidelink transmission.

Addressed to at least one of the above problems, embodiments of this disclosure provide a sidelink transmission method and apparatus.

According to an aspect of the embodiments of this disclosure, there is provided a sidelink transmission apparatus, applicable to a terminal equipment side, the apparatus including:

a first receiving unit configured to receive sidelink control information at a physical layer (PHY), the sidelink control information being used to trigger report of sidelink channel state information;

a first generating unit configured to generate sidelink channel state information at the physical layer; and

a first transmitting unit configured to transmit the sidelink control information and the sidelink channel state information from the physical layer to a media access control (MAC) layer.

According to another aspect of the embodiments of this disclosure, there is provided a sidelink transmission apparatus, applicable to a terminal equipment side, the apparatus including:

a second receiving unit configured to receive sidelink control information at a media access control (MAC) layer, the sidelink control information being used to trigger sidelink channel state information reporting; and

a third generating unit configured to generate a sidelink channel state information reporting MAC control element in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer.

According to a further aspect of the embodiments of this disclosure, there is provided a sidelink transmission apparatus, applicable to a transmitting terminal equipment, the apparatus including:

a first selecting unit configured to, when there exist a sidelink logical channel and a sidelink MAC control element to be transmitted for destination terminal equipments and the sidelink logical channel and the sidelink MAC control element have identical priorities, select a destination terminal equipment to which the sidelink logical channel belongs, or select a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, select a destination terminal equipment according to an descending order of priorities of the other sidelink logical channel and/or sidelink MAC control element; or select a destination terminal equipment according to remaining latencies of all sidelink logical channels and the sidelink MAC control elements to be transmitted; or select a destination terminal equipment according to a buffer size of a sidelink logical channel; or select a destination terminal equipment according to the number of times of previously selecting a sidelink logical channel and a sidelink MAC control element;

a second selecting unit configured to select a sidelink logical channel and/or the sidelink MAC control element, the selected sidelink logical channel and/or sidelink MAC control element corresponding to the selected destination terminal equipment; and

an allocating unit configured to allocate a sidelink resource for the sidelink logical channel and/or sidelink MAC control element.

An advantage of the embodiments of this disclosure exists in that the physical layer of the terminal equipment indicates the CSI and SCI to the MAC when it obtains the CSI, or the MAC entity generates a corresponding MAC CE when it has channel state information. Hence, a valid CSI measurement result may be transmitted, and waste of sidelink resources may be avoided at the same time.

Another advantage of the embodiments of this disclosure exists in that when there is a sidelink logical channel and a sidelink MAC CE to be transmitted for the destination terminal equipment and the sidelink logical channel and the sidelink MAC CE have identical priorities, a corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a flow of existing sidelink CSI reporting;

FIG. 3 is a schematic diagram of the sidelink transmission method of the embodiment of the first aspect of this disclosure;

FIG. 4 is a schematic diagram of a process of generating an MAC CE of the embodiment of the first aspect of this disclosure;

FIG. 5 is a schematic diagram of the sidelink transmission method of the embodiment of the first aspect of this disclosure;

FIG. 6 is a schematic diagram of the sidelink transmission method of the embodiment of the second aspect of this disclosure;

FIG. 7 is a schematic diagram of a process of generating an MAC CE of the embodiment of the second aspect of this disclosure;

FIG. 8 is a schematic diagram of a process of generating an MAC CE of the embodiment of the second aspect of this disclosure;

FIG. 9 is a schematic diagram of the sidelink transmission apparatus of the embodiment of the third aspect of this disclosure;

FIG. 10 is a schematic diagram of the sidelink transmission apparatus of the embodiment of the fourth aspect of this disclosure;

FIG. 11A and FIG. 11B are schematic diagrams of scenarios of LCHs and having MAC CEs to be transmitted for two destination terminal equipments respectively according to the embodiment of this disclosure;

FIG. 12 is a schematic diagram of a scenario of an LCH and an MAC CE having identical priorities for two destination terminal equipments according to the embodiment of this disclosure;

FIG. 13 is a schematic diagram of the sidelink transmission method of the embodiment of the fifth aspect of this disclosure;

FIG. 14 is a schematic diagram of the sidelink transmission apparatus of the embodiment of the sixth aspect of this disclosure;

FIG. 15 is a schematic diagram of the information feedback method of the embodiment of the seventh aspect of this disclosure;

FIG. 16 is a schematic diagram of the information feedback apparatus of the embodiment of the eighth aspect of this disclosure; and

FIG. 17 is a schematic diagram of a structure of the terminal equipment of the embodiment of the ninth aspect of this disclosure.

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the terms of the appended claims. Various embodiments of this disclosure shall be described below with reference to the accompanying drawings. These embodiments are illustrative only, and are not intended to limit this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal device” refers to, for example, equipment accessing to a communication network and receiving network services via a network device, and may also be referred to as “terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above. In this description, “a device” may refer to a network device, and may refer to a terminal equipment, unless otherwise specified.

Scenarios in the embodiments of this disclosure shall be described below by way of examples.

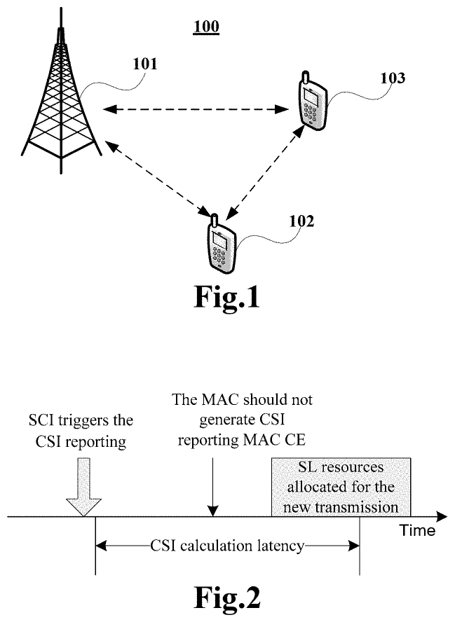

FIG. 1 is a schematic diagram of a communication system of an embodiment of this disclosure, in which a case where terminal equipments and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiments of this disclosure, existing services or services that may be implemented in the future may be performed between the network device 101 and the terminal equipments 102, 103 or between the terminal equipments 102, 103. For example, such services may include but not limited to an enhanced mobile broadband (eMBB), massive machine type communication (MTC), ultra-reliable and low-latency communication (URLLC), and vehicle-to-everything (V2X), etc. This disclosure shall be described by taking that LTE or NR uplink or downlink communication is performed between the network device 101 and the terminal equipment 102 and LTE or NR sidelink communication (SL communication) is performed between the terminal equipments 102, 103 as examples. The SL communication here is, for example, communication related to V2X services.

The embodiments of this disclosure shall be described below with reference to the accompanying drawings.

A terminal equipment as a transmitter of service data shall be hereinafter referred to as a transmitting terminal equipment, which transmits sidelink data to one or more other terminal equipments (a receiving terminal equipment or a destination terminal equipment).

In existing techniques, when a transmitting terminal equipment requests for CSI reporting, it will transmit to a receiving terminal equipment sidelink control information (SCI) triggering CSI reporting and a CSI reference signal (CSI-RS) used for CSI measurement. In receiving the SCI, a physical layer of the receiving terminal equipment shall measure the CSI reference signal and calculate corresponding CSI, including a channel quality indicator (CQI) and a rank indicator (RI), the calculation needing some time or delay (usually a time of several symbols, which is hereinafter referred to as CSI calculation delay). According to existing standards, an MAC layer of the receiving terminal equipment will generate a sidelink CSI reporting MAC CE if there exist sidelink resources for new transmission when the sidelink CSI reporting is triggered by the SCI and is not cancelled. FIG. 2 is a schematic diagram of a flow of existing sidelink CSI reporting. As shown in FIG. 2, it was found by the inventors that due to the CSI calculation delay of the physical layer, the sidelink resources for new transmission may arrive before the physical layer calculates the CQI and RI, in which case the MAC layer shall not generate the MAC CE of the sidelink CSI reporting; otherwise, it will lead to waste of sidelink resources. In the embodiments of this disclosure, the physical layer of the terminal equipment indicates the CSI and SCI to the MAC layer after obtaining the CSI, or an MAC entity generates a corresponding MAC CE when there exists channel state information. Hence, valid CSI measurement results may be transmitted, and waste of sidelink resources may be avoided at the same time. The following description shall be given with reference to the embodiments of the first to fourth aspects.

### Embodiment of the First Aspect

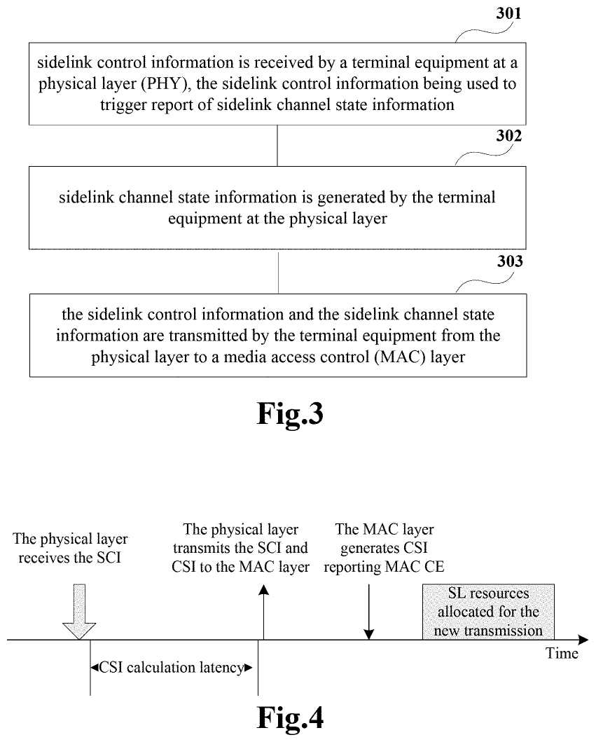

The embodiment of this disclosure provides a sidelink transmission method, which shall be described from a terminal equipment side. FIG. 3 is a schematic diagram of the sidelink transmission method of the embodiment of this disclosure. As shown in FIG. 3, the method includes:

301: sidelink control information is received by a terminal equipment at a physical layer (PHY), the sidelink control information being used to trigger report of sidelink channel state information;

302: sidelink channel state information is generated by the terminal equipment at the physical layer; and

303: the sidelink control information and the sidelink channel state information are transmitted by the terminal equipment from the physical layer to a media access control (MAC) layer.

According to the embodiment of this disclosure, the physical layer of the terminal equipment indicates the CSI and SCI to the MAC after obtaining the CSI. Hence, a valid CSI measurement result may be transmitted, and waste of sidelink resources may be avoided at the same time.

It should be noted that FIG. 3 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, the terminal equipment receives, at the physical layer, the sidelink control information transmitted by a peer terminal equipment via a physical sidelink control channel (PSCCH), the sidelink control information being used to trigger sidelink channel state information reporting (aperiodic CSI reporting). The sidelink control information includes a CSI request field (CSI request), and the CSI reporting is triggered by setting the CSI request field to be 1. The CSI includes channel quality indicator (CQI) and a rank indicator (RI).

In some embodiments, the method may further include: a CSI reference signal is received by the terminal equipment at the physical layer; measuring the reference signal by the terminal equipment, including channel measurement and interference measurement, and a measurement quantity including a signal-to-noise ratio, and a received signal strength, etc.; and generating sidelink channel state information by the terminal equipment at the physical layer, the sidelink channel state information including a CQI and RI, and being able to be generated in an existing method.

In existing techniques, it is not specified when a physical layer of a terminal equipment transmits SCI to an MAC layer, the physical layer may transmit the SCI to the MAC layer after receiving the SCI, without waiting for the CSI result and then transmitting to the MAC layer. In the embodiment of this disclosure, different from the existing techniques, the physical layer of the terminal equipment transmits the CSI and the previously received SCI to the MAC layer after generating the sidelink CSI, for example, it may transmit the CSI and the SCI at the same time to the MAC layer, that is, indicating the CSI and the SCI to the MAC layer together. However, the embodiment of this disclosure is not limited thereto, and after the CSI is obtained, the CSI and the SCI may be respectively transmitted to the MAC layer.

In some embodiments, the method may further include: a sidelink channel state information reporting MAC control element is generated by the terminal equipment in a case where the sidelink control information and the sidelink channel state information are received at the media access control layer and the media access control layer entity has a sidelink resource allocated for new transmission, and the sidelink channel state information is reported by the terminal equipment. The sidelink resource allocated for new transmission indicates that the sidelink resource is used for new transmission on the sidelink, not for retransmission service on the sidelink, and the MAC entity indicates that the sidelink CSI reporting MAC CE is generated in a multiplexing and assembly procedure, the CSI reporting MAC CE being used to carry the CQI and RI reported by the physical layer, that is, the terminal equipment carries the CSI by using the generated CSI reporting MAC CE and reports CSI reporting MAC CE to the peer terminal equipment.

FIG. 4 is a schematic diagram of a process of generating an MAC CE of the embodiment of the first aspect of this disclosure. As shown in FIG. 4, after obtaining the CSI (i.e. after the CSI calculation delay), the physical layer of the terminal equipment transmits the CSI (i.e. the CQI and RI) and the previously received SCI to the MAC layer. The MAC layer of the terminal equipment generates the CSI reporting MAC CE only after receiving the CSI. Hence, the sidelink resources allocated for the new transmission will not be wasted, and valid CSI results may be transmitted.

In some embodiments, after generating the CSI reporting MAC CE, the MAC entity cancels the triggered sidelink CSI reporting.

FIG. 5 is a schematic diagram of the sidelink transmission method. As shown in FIG. 5, the method includes:

501: SCI is received by the terminal equipment transmitted by a peer terminal equipment at the physical layer (PHY), the SCI being used to trigger report of sidelink CSI;

502: sidelink CSI is generated by the terminal equipment at the physical layer;

503: the SCI and a sidelink CSI result are transmitted by the terminal equipment from the physical layer to a medium access control (MAC) layer;

504: an MAC control element (CE) of sidelink channel state information reporting (CSI reporting) is generated by an MAC entity in a case where the MAC entity has sidelink resources allocated for new transmission;

505: triggered sidelink CSI reporting is cancelled by the MAC entity; and

506: the terminal equipment carries the CSI by using the MAC CE to report the MAC CE to the peer terminal equipment.

It should be noted that an order of 505 and 506 is not limited, that is, 505 may be executed before 506, or 505 may be executed after 506, or 505 and 506 may be executed simultaneously.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the physical layer of the terminal equipment indicates the CSI and SCI to the MAC when it obtains the CSI. Hence, a valid CSI measurement result may be transmitted, and waste of sidelink resources may be avoided at the same time.

### Embodiment of the Second Aspect

The embodiment of this disclosure provides a sidelink transmission method, which shall be described from a terminal equipment side, with contents identical to those in the embodiment of the first aspect being not going to be described herein any further.

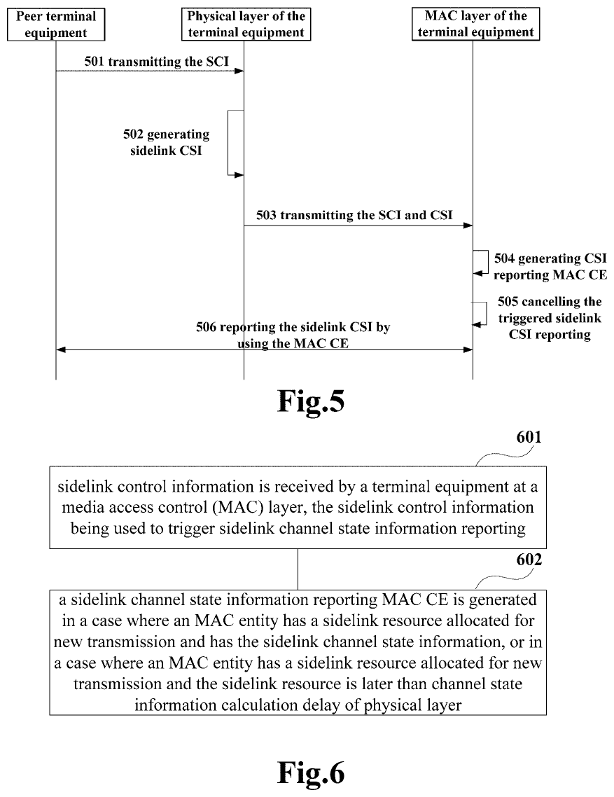

FIG. 6 is a schematic diagram of the sidelink transmission method of the embodiment of this disclosure. As shown in FIG. 6, the method includes:

601: sidelink control information is received by a terminal equipment at a media access control (MAC) layer, the sidelink control information being used to trigger sidelink channel state information reporting; and

602: a sidelink channel state information reporting MAC control element is generated in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer.

According to the embodiment of this disclosure, the MAC entity generates the corresponding MAC CE in the case of having the channel state information, so that a valid CSI measurement result may be transmitted, and waste of sidelink resources may be avoided at the same time.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

In some embodiments, at the physical layer, the terminal equipment first receives the sidelink control information transmitted by the peer terminal equipment via the physical sidelink control channel (PSCCH). Implementation of the sidelink control information may refer to the embodiment of the first aspect, and after receiving the SCI, the physical layer transfers the SCI to the MAC entity to trigger the sidelink channel state information reporting.

In some embodiments, the sidelink CSI reporting MAC control element (CE) is generated when the MAC entity has the sidelink resources allocated for the new transmission and has the sidelink channel state information. The sidelink resources allocated for new transmission indicate that the sidelink resources are used for new transmission on the sidelink, not for retransmission service on the sidelink, and the MAC entity indicates the sidelink CSI reporting MAC CE is generated in a multiplexing and assembly procedure, the sidelink CSI reporting MAC CE being used to carry CQI and RI. In other words, the MAC entity will consider whether it already has a CSI result in generating the sidelink CSI reporting MAC CE, wherein the having the sidelink CSI includes that the MAC entity has valid CSI or the MAC entity obtains the sidelink CSI from the physical layer, the CSI including the CQI and RI.

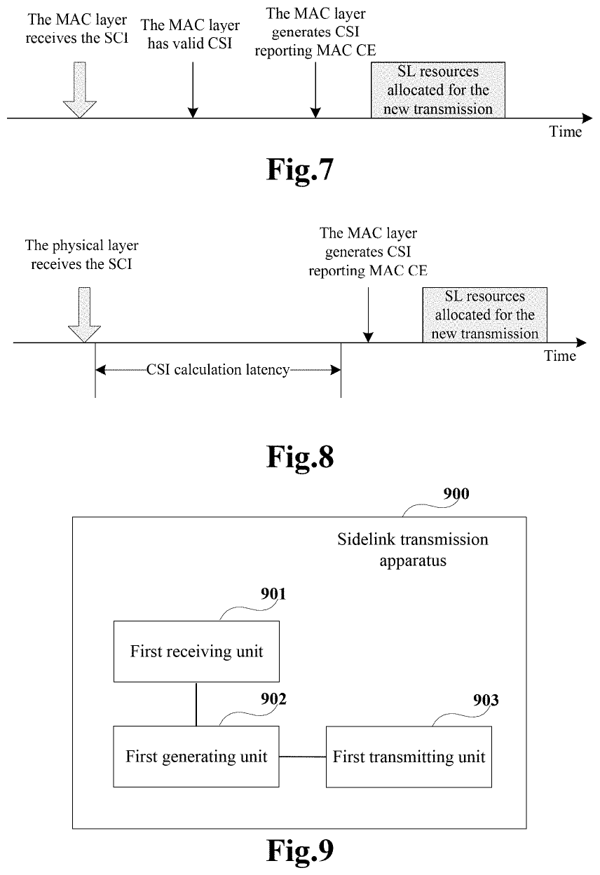

FIG. 7 is a schematic diagram of a process of generating an MAC CE by the MAC entity. As shown in FIG. 7, after the MAC entity has valid CSI, it generates the sidelink CSI reporting MAC CE. Therefore, waste of sidelink resources allocated for the new transmission will not be caused, and valid CSI measurement results may be transmitted. The MAC entity may have the CSI by acquiring the CSI from the physical layer.

In some embodiments, the sidelink channel state information reporting MAC control element (CE) is generated when the MAC entity has a sidelink resource allocated for new transmission and the sidelink resource is later than calculation delay of the physical layer channel state information. FIG. 8 is a schematic diagram of a process of generating an MAC CE by the MAC entity. As shown in FIG. 8, as the sidelink resource is later than the CSI calculation delay, in other words, the sidelink resource will not arrive before the physical layer generates the CSI, when the MAC layer of the terminal equipment has sidelink resources for the new transmission, it generates the CSI reporting MAC CE, which will not cause waste of the sidelink resources allocated for the new transmission, and valid CSI measurement results may be transmitted.

In some embodiments, after generating the CSI reporting MAC CE, the MAC entity cancels the triggered sidelink CSI reporting.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the MAC entity generates a corresponding MAC CE when it has channel state information. Hence, a valid CSI measurement result may be transmitted, and waste of sidelink resources may be avoided at the same time.

### Embodiment of the Third Aspect

The embodiment of this disclosure provides a sidelink transmission apparatus. The apparatus may be, for example, a terminal equipment (such as the above-described terminal equipment), or one or some components or assemblies configured in a terminal equipment, with contents identical to those in the embodiment of the first aspect being not going to be described herein any further.

FIG. 9 is a schematic diagram of the sidelink transmission apparatus of the embodiment of this disclosure. In some embodiments, as shown in FIG. 9, a sidelink transmission apparatus 900 includes:

a first receiving unit 901 configured to receive sidelink control information at a physical layer (PHY), the sidelink control information being used to trigger report of sidelink channel state information;

a first generating unit 902 configured to generate sidelink channel state information at the physical layer; and

a first transmitting unit 903 configured to transmit the sidelink control information and the sidelink channel state information from the physical layer to a media access control (MAC) layer.

According to the embodiment of this disclosure, the physical layer of the terminal equipment indicates the CSI and the SCI to the MAC when the CSI is obtained, so that valid CSI measurement results may be transmitted, and waste of sidelink resources may be avoided at the same time.

In some embodiments, the first receiving unit 901 receives, at the physical layer, the sidelink control information transmitted by a peer terminal equipment via a physical sidelink control channel (PSCCH), the sidelink control information being used to trigger sidelink channel state information reporting (aperiodic CSI reporting). The sidelink control information includes a CSI request field (CSI request), and the CSI reporting is triggered by setting the CSI request field to be 1. The CSI includes channel quality indicator (CQI) and a rank indicator (RI).

In some embodiments, the first receiving unit 901 may further receive a CSI reference signal at the physical layer, and the terminal equipment measures the reference signal, including channel measurement and interference measurement, and a measurement quantity including a signal-to-noise ratio, and a received signal strength, etc., and the first generating unit 902 generates sidelink channel state information at the physical layer, the sidelink channel state information including a CQI and RI, and being able to be generated in an existing method.

In some embodiments, after the CSI is generated in the sidelink, the first transmitting unit 903 transmits the CSI and the previously received SCI to the MAC layer, such as transmitting the CSI and the SCI to the MAC layer at the same time, that is, the CSI and the SCI are indicated to the MAC layer together; however, the embodiment of this disclosure is not limited thereto, and the CSI and the SCI may respectively be transmitted to the MAC layer after the CSI is obtained.

In some embodiments, the apparatus may further include (not shown, optional):

a second generating unit configured to generate a sidelink channel state information reporting MAC control element in a case where the sidelink control information and the sidelink channel state information are received at the media access control layer and the media access control layer has a sidelink resource allocated for new transmission; and

a reporting unit configured to report the sidelink channel state information.

In some embodiments, the sidelink resources allocated for new transmission indicate that the sidelink resources are used for new transmission on the sidelink, not for retransmission service on the sidelink, and the second generating unit indicates a multiplexing and assembly procedure to generate the sidelink CSI reporting MAC CE by using the MAC entity, the sidelink CSI reporting MAC CE being used to carry CQI and RI reported by the physical layer, that is, the reporting unit carries the CSI by using the generated CSI reporting MAC CE to report the CSI reporting MAC CE to the terminal equipment.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the sidelink transmission apparatus 900 may further include other components or modules, and reference may be made to the related techniques for specific contents of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the physical layer of the terminal equipment indicates the CSI and SCI to the MAC when it obtains the CSI. Hence, a valid CSI measurement result may be transmitted, and waste of sidelink resources may be avoided at the same time.

### Embodiment of the Fourth Aspect

The embodiment of this disclosure provides a sidelink transmission apparatus. The apparatus may be, for example, a terminal equipment (such as the above-described terminal equipment), or one or some components or assemblies configured in a terminal equipment, with contents identical to those in the embodiment of the second aspect being not going to be described herein any further.

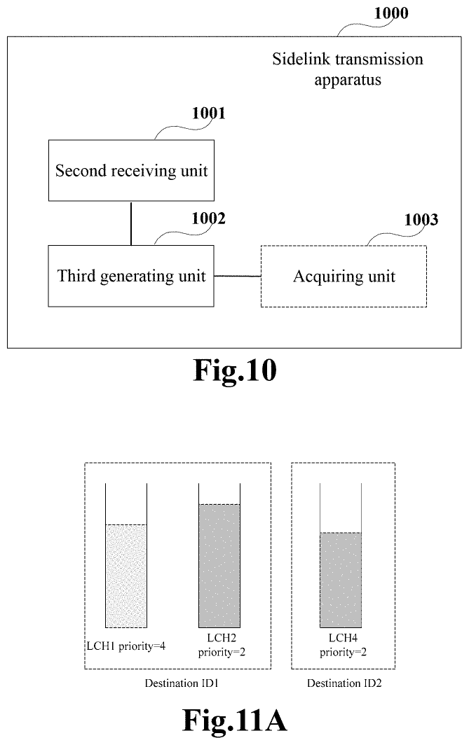

FIG. 10 is a schematic diagram of the sidelink transmission apparatus of the embodiment of this disclosure. In some embodiments, as shown in FIG. 10, a sidelink transmission apparatus 1000 includes:

a second receiving unit 1001 configured to receive sidelink control information at a media access control (MAC) layer, the sidelink control information being used to trigger sidelink channel state information reporting; and

a third generating unit 1002 configured to generate a sidelink channel state information reporting MAC control element in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer.

According to the embodiment of this disclosure, the MAC entity generates the corresponding MAC CE in the case of having the channel state information, so that valid CSI measurement results may be transmitted, and waste of sidelink resources may be avoided at the same time.

In some embodiments, at the physical layer, the second receiving unit 1001 first receives the sidelink control information transmitted by the peer terminal equipment via the physical sidelink control channel (PSCCH). Implementation of the sidelink control information may refer to the embodiment of the first aspect, and after receiving the SCI, the physical layer transfers the SCI to the MAC entity to trigger the sidelink channel state information reporting. In some embodiments, the in the case where the MAC entity has sidelink resources allocated for the new transmission and has the sidelink channel state information, the third generating unit 1003 generates the sidelink channel state information MAC reporting control unit (CE). The sidelink resources allocated for the new transmission indicates that the sidelink resources are used for new transmission on the sidelink, not for retransmission services on the sidelink, and the third generating unit 1003 uses the MAC entity to indicate that the sidelink CSI reporting MAC CE is generated in a multiplexing and assembly procedure, the sidelink CSI reporting MAC CE being used to carry CQI and RI. In other words, in generating the CSI reporting MAC CE, the third generating unit 1003 will consider whether it already has CSI, wherein the having the sidelink CSI includes that the MAC entity has valid CSI or the MAC entity obtains the sidelink from the physical layer CSI, the CSI including CQI and RI. Therefore, the apparatus may further include (optional): an acquiring unit 1003 configured to obtain the sidelink channel state information by the media access control layer from the physical layer.

In some embodiments, the third generation unit 1002 generates the sidelink channel state information reporting MAC control element (CE) when the MAC entity has the sidelink resource allocated for new transmission and the sidelink resource is later than the physical layer channel state information calculation delay, that is, the sidelink resource will not arrive before the physical layer generates the CSI. Therefore, the MAC layer of the terminal equipment generates the CSI reporting MAC CE when there exists a sidelink resource for new transmission, which will not cause waste of the sidelink resources allocated for the new transmission, and valid CSI measurement results may be transmitted.

In some embodiments, after generating the CSI reporting MAC CE, the third generating unit 1002 cancels the triggered sidelink CSI reporting by using the MAC entity. The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the sidelink transmission apparatus 1000 may further include other components or modules, and reference may be made to the related techniques for specific contents of these components or modules.

Furthermore, for the sake of simplicity, connection relationships between the components or modules or signal profiles thereof are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the MAC entity generates a corresponding MAC CE when it has channel state information. Hence, a valid CSI measurement result may be transmitted, and waste of sidelink resources may be avoided at the same time.

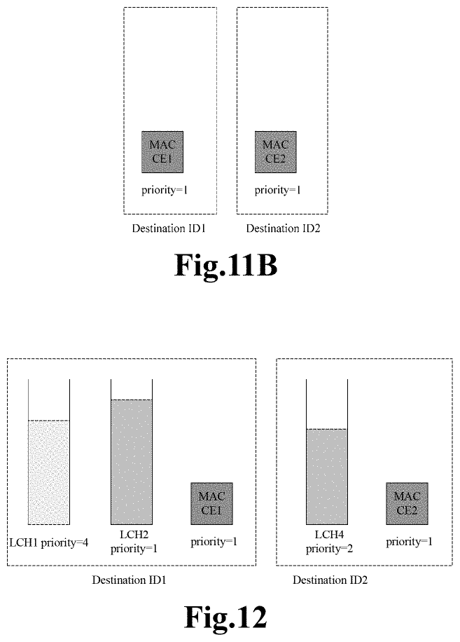

In existing techniques, for a time of new transmission at an MAC layer by a transmitting terminal equipment, after receiving a sidelink grant transmitted by a network device, the transmitting terminal equipment needs to first select a corresponding destination terminal equipment, and then allocate sidelink resources to a logical channel (LCH) and/or an MAC CE to which the destination terminal equipment corresponds. In existing standards, it is stipulated that the transmitting terminal equipment selects a destination terminal equipment to which a logical channel with a highest priority satisfying all conditions or an MAC CE belongs in a logical channel priority processing (LCP) procedure. If there are multiple destination terminal equipments having MAC CEs to be transmitted, it is achieved by the terminal equipment to determine which destination terminal equipment to which an MAC CE belongs is selected, and if there are multiple destination terminal equipments with LCHs satisfying conditions and having identical highest priorities, it is achieved by the terminal equipment to determine which destination terminal equipment to which an LCH belongs is selected; wherein the LCHs satisfying conditions may be LCHs satisfying logical channel priority processing mapping constraints and/or LCHs with Bj values (the Bj values indicate the number of currently available tokens in a token bucket, each token corresponding to data of 1 byte, and a Bj is initialized to be 0 when a logical channel is established) greater than zero, etc. FIG. 11A and FIG. 11B are schematic diagrams of scenarios of LCHs and having MAC CEs to be transmitted by a transmitting terminal equipment for two destination terminal equipments respectively. As shown in FIG. 11A, for both destination terminal equipments (destination ID) 1 and 2, there is only LCH data to be transmitted and highest priorities of LCHs satisfying the conditions are all 2. As shown in FIG. 11B, for both destination terminal equipments (Destination ID) 1 and 2, they have only MAC CEs to be transmitted and priorities of the MAC CEs are all 1. In both cases, it is achieved by the terminal equipment to determine which destination terminal equipment is selected. However, it was found by the inventors that when a sidelink LCH and a sidelink MAC CE have identical priorities, it is not specified in existing techniques which destination terminal equipment the terminal equipment should select in logical channel priority processing. FIG. 12 is a schematic diagram of a scenario of the sidelink logical channel and the MAC CE having identical priorities. As shown in FIG. 12, the transmitting terminal equipment has two logical channels LCH1 (with a priority of 4) and LCH2 (with a priority of 1) and an MAC CE1 (with a priority of 1) for destination terminal equipment 1 and one logical channel LCH4 (with a priority of 2) and an MAC CE2 (with a priority of 1) for destination terminal equipment 2. Priorities of the logical channel and MAC CE with a highest priority are both 1, and the transmitting terminal equipment does not know which destination terminal equipment is selected.

In the embodiment of this disclosure, when there exists a sidelink logical channel and a sidelink MAC CE to be transmitted for the destination terminal equipment and the sidelink logical channel and the sidelink MAC CE have identical priorities, the corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences, which shall be described below with reference embodiments of the fifth to sixth aspects.

### Embodiment of the Fifth Aspect

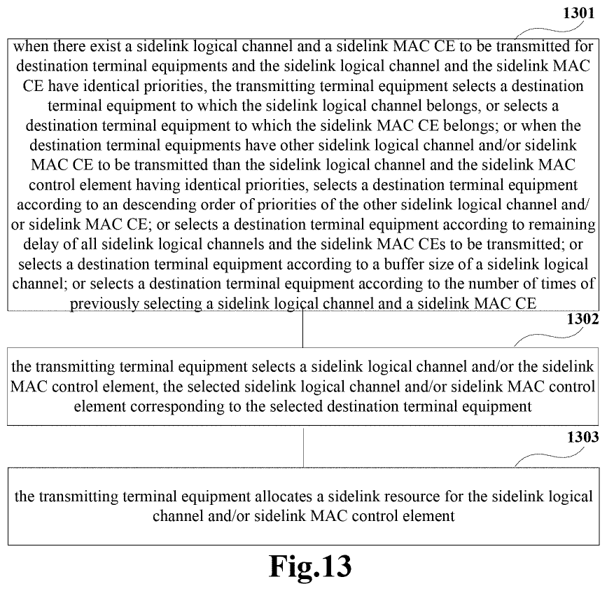

The embodiment of this disclosure provides a sidelink transmission method, which shall be described from a transmitting terminal equipment side. FIG. 13 is a schematic diagram of the sidelink transmission method of the embodiment of this disclosure. As shown in FIG. 13, the method includes:

1301: when there exist a sidelink logical channel and a sidelink MAC control element to be transmitted for destination terminal equipments and the sidelink logical channel and the sidelink MAC control element have identical priorities, the transmitting terminal equipment selects a destination terminal equipment to which the sidelink logical channel belongs, or selects a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, selects a destination terminal equipment according to an descending order of priorities of the other sidelink logical channel and/or sidelink MAC control element; or selects a destination terminal equipment according to remaining delay of all sidelink logical channels and the sidelink MAC control elements to be transmitted; or selects a destination terminal equipment according to a buffer size of a sidelink logical channel; or selects a destination terminal equipment according to the number of times of previously selecting a sidelink logical channel and a sidelink MAC control element;

1302: the transmitting terminal equipment selects a sidelink logical channel and/or the sidelink MAC control element, the selected sidelink logical channel and/or sidelink MAC control element corresponding to the selected destination terminal equipment; and

1303: the transmitting terminal equipment allocates a sidelink resource for the sidelink logical channel and/or sidelink MAC control element.

According to the above embodiment, when there exists a sidelink logical channel and a sidelink MAC CE to be transmitted for the destination terminal equipment and the sidelink logical channel and the sidelink MAC CE have identical priorities, the corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences.

It should be noted that FIG. 13 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 13.

In some embodiments, the logical channel may be a logical channel having data to be transmitted and/or a logical channel with a Bj value greater than zero and/or satisfying logical channel priority processing mapping constraints, the MAC CE may be a triggered or generated or to-be-generated MAC CE, such as a CSI reporting MAC CE; however, this embodiment is not limited thereto; and the priority is a configured logical channel priority or a priority of the MAC CE, that is, the priority of the logical channel is a logical channel priority configured by the network device, the lower a value of the priority, the higher the priority, which is usually 1-8, and the priority of the MAC CE may be predefined or pre-configured, such as 1.

In some embodiments, priorities of an LCH and an MAC CE with identical priorities are highest priorities, and a sidelink logical channel and a sidelink MAC CE with identical priorities belong to the same or different destination terminal equipments. As shown in FIG. 12, the highest priority is 1, which are LCH2 and MAC CE1 to which a destination terminal equipment 1 corresponds and MAC CE2 to which destination terminal equipment 2 corresponds, respectively. MAC CE1 and LCH2 belong to the same destination terminal equipment, and LCH2 and MAC CE2 belong to different destination terminal equipments.

In some embodiments, the transmitting terminal equipment selects the destination terminal equipment to which the sidelink logical channel belongs; as shown in FIG. 12, the transmitting terminal equipment selects the destination terminal equipment to which LCH2 belongs. In addition, when priorities of LCHs of at least two destination terminal equipments satisfying conditions are identical, similar to the existing techniques, it is achieved by the transmitting terminal equipment to determine which destination terminal equipment to which an LCH belongs is selected.

In some embodiments, the transmitting terminal equipment selects the destination terminal equipment to which the sidelink MAC CE belongs; as shown in FIG. 12, the transmitting terminal equipment selects destination terminal equipment 1 to which MAC CE1 belongs or destination terminal 2 to which MAC CE2 belongs. In addition, when priorities of MAC CEs of at least two destination terminal equipments are identical, similar to the existing techniques, it is achieved by the transmitting terminal equipment to determine which destination terminal equipment to which an MAC CE is selected.

In some embodiments, when the destination terminal equipment has other sidelink logical channel and/or sidelink MAC CE to be transmitted in addition to the sidelink logical channel and the sidelink MAC CE with identical priorities, the transmitting terminal equipment selects a destination terminal equipment according to a descending order of priorities of the other sidelink logical channel and/or sidelink MAC CE to be transmitted; wherein when the logical channels and the sidelink MAC CEs with identical priorities belong to the same destination terminal equipment, the same destination terminal equipment is selected; and if the sidelink logical channels and the sidelink MAC CEs with identical priorities belong to different destination terminal equipments, the other sidelink logical channel and/or sidelink MAC CE to be transmitted are ranked in a descending order of priorities, and a destination terminal equipment to which a sidelink logical channel and/or sidelink MAC CE with a higher priority is selected therefrom. As shown in FIG. 12, except for LCH2, MAC CE1 and MAC CE2 with priorities of 1, LCH2 and MAC CE2 belong to different destination terminal equipments. Destination terminal equipment 1 still has LCH1 to be transmitted, destination terminal equipment 2 still has LCH4 to be transmitted, and the transmitting terminal equipment ranks the priorities of LCH4 and LCH1 in an ascending order into LCH4 with a priority of 2 and LCH1 with a priority of 1, that is, destination terminal equipment 2 to which LCH4 with a higher priority belongs is selected. As shown in FIG. 12, it is assumed that in a scenario where a destination terminal equipment has no MAC CE2 to be transmitted, that is, when the sidelink logical channel and the sidelink MAC CE with identical priorities (highest) belong to the same destination terminal equipment (both LCH2 and MAC CE1 belong to destination terminal equipment 1), the same destination terminal equipment 1 is directly selected without considering other transmitted sidelink logical channels and/or sidelink MAC CEs with lower priorities.

In some embodiments, the transmitting terminal equipment selects a destination terminal equipment according to remaining delay of all sidelink logical channels and the sidelink MAC CEs to be transmitted, wherein a destination terminal equipment to which a sidelink logical channel or sidelink MAC CE with remaining delay that is shortest or shorter than a first threshold belongs is selected. As shown in FIG. 12, according to the remaining delay of LCH2, MAC CE1 and MAC CE2, a destination terminal equipment to which an LCH or MAC CE with remaining delay that is shortest or shorter than the first threshold belongs is selected. For example, remaining delay of an LCH may be remaining packet delay budget (PDB) to which the LCH corresponds, and remaining delay of an MAC CE may be latency bound to which the MAC CE corresponds, such as 3 to 20 milliseconds.

In some embodiments, the transmitting terminal equipment selects a destination terminal equipment according to a buffer size of a sidelink logical channel; wherein when the buffer size of the sidelink logical channel is greater than or equal to a second threshold, a destination terminal equipment to which the sidelink logical channel belongs is selected; and when the buffer size of the sidelink logical channel is less than the second threshold, a destination terminal equipment to which the sidelink MAC CE belongs is selected. Furthermore, when there exist at least two destination terminal equipments having MAC CEs to be transmitted, it is achieved by the terminal equipment to determine which destination terminal equipment to which an MAC CE belongs is selected, or determine which destination terminal equipment to which an MAC CE belongs from destination terminal equipments different from the destination terminal equipment to which the LCH belongs, without considering an MAC CE belonging to the same destination terminal equipment to which the LCH belongs is selected. As shown in FIG. 12, according to the buffer size of the LCH2, when the buffer size of the LCH2 is greater than or equal to the second threshold, destination terminal equipment 1 is selected, otherwise, destination terminal equipment 2 is selected, or it is achieved by the terminal equipment to determine which destination terminal equipment to which an MAC CE belongs is selected.

In some embodiments, the transmitting terminal equipment selects a destination terminal equipment according to the number of times of previously selecting sidelink logical channels and the MAC CEs; wherein a destination terminal equipment to which the LCH belongs and a destination terminal equipment to which the MAC CE belongs are selected alternately. For example, in selecting transmitting sidelink logical channels first, the destination terminal equipment to which the MAC CE belongs is selected this time. In addition, when there exist at least two destination terminal equipments having MAC CEs to be transmitted, it is achieved by the terminal equipment to determine which destination terminal equipment to which an MAC CE belongs is selected, or it is achieved by the terminal equipment to determine which destination terminal equipment to which an MAC CE belongs from destination terminal equipments different from the destination terminal equipment to which the LCH belongs is selected, without considering an MAC CE belonging to the same destination terminal equipment to which the LCH belongs. In selecting transmitting MAC CEs first, the destination terminal equipment to which the sidelink logical channel belongs is selected this time. In addition, when there exist at least two destination terminal equipments having LCHs to be transmitted, it is achieved by the terminal equipment to determine which destination terminal equipment to which an LCH belongs is selected, or it is achieved by the terminal equipment to determine which destination terminal equipment to which an LCH belongs from destination terminal equipments different from the destination terminal equipment to which the MAC CE belongs is selected, without considering an LCH belonging to the same destination terminal equipment to which the MAC CE belongs, wherein the sidelink LCH and MAC CE selected this time are the above sidelink LCH and MAC CE having identical highest priorities. As shown in FIG. 12, in selecting an LCH first, the destination terminal equipment to which the MAC CE belongs is selected this time, for example, selection of the destination terminal equipment is achieved by the terminal equipment, or destination terminal equipment 2 different from the destination terminal equipment to which LCH2 belongs is selected, and in selecting an MAC CE first, destination terminal equipment 1 to which LCHs belongs is selected this time.

In some embodiments, after the destination terminal equipment is determined, a sidelink logical channel and/or the sidelink MAC CE belonging to the destination terminal equipment are selected, for example, a logical channel having data waiting for being transmitted and/or a logical channel satisfying logical channel mapping constraints may be selected. The transmitting terminal equipment allocates sidelink resources for the sidelink logical channel and/or the sidelink MAC CE, such as allocating sidelink resources according to a descending order of a priority of the logical channel and/or a priority of the MAC CE, and transmits the LCH and/or the MAC CE by using the allocated sidelink resources.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that when there is a sidelink logical channel and a sidelink MAC CE to be transmitted for the destination terminal equipment and the sidelink logical channel and the sidelink MAC CE have identical priorities, a corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences.

### Embodiment of a Sixth Aspect

The embodiment of this disclosure provides a sidelink transmission apparatus. The apparatus may be, for example, a terminal equipment (such as the above-described terminal equipment), or one or some components or assemblies configured in a terminal equipment, with contents identical to those in the embodiment of the fifth aspect being not going to be described herein any further.

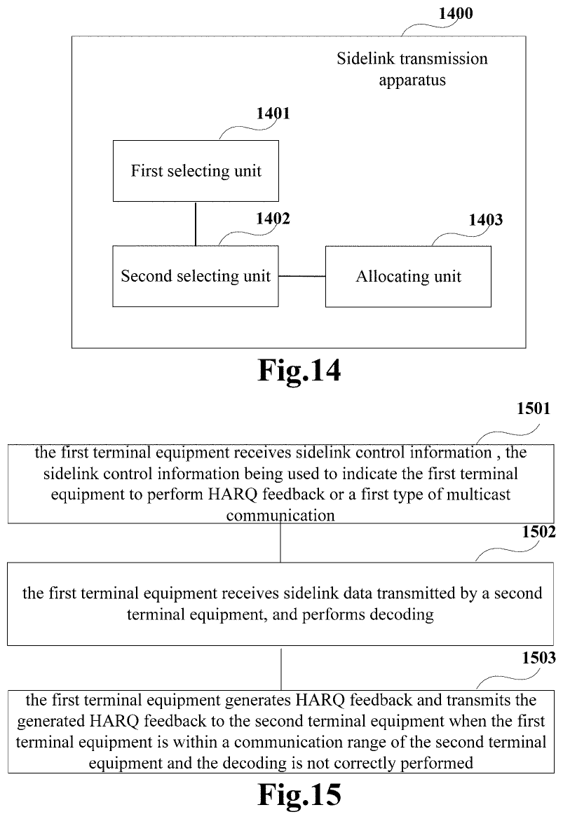

FIG. 14 is a schematic diagram of the sidelink transmission apparatus of the embodiment of this disclosure. In some embodiments, as shown in FIG. 14, a sidelink transmission apparatus 1400 includes:

a first selecting unit 1401 configured to, when there exist a sidelink logical channel and a sidelink MAC control element to be transmitted for destination terminal equipments and the sidelink logical channel and the sidelink MAC control element have identical priorities, select a destination terminal equipment to which the sidelink logical channel belongs, or select a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, select a destination terminal equipment according to an descending order of priorities of the other sidelink logical channel and/or sidelink MAC control element; or select a destination terminal equipment according to remaining latencies of all sidelink logical channels and the sidelink MAC control elements to be transmitted; or select a destination terminal equipment according to a buffer size of a sidelink logical channel; or select a destination terminal equipment according to the number of times of previously selecting a sidelink logical channel and a sidelink MAC control element;

a second selecting unit 1402 configured to select a sidelink logical channel and/or the sidelink MAC control element, the selected sidelink logical channel and/or sidelink MAC control element corresponding to the selected destination terminal equipment; and an allocating unit 1403 configured to allocate a sidelink resource for the sidelink logical channel and/or sidelink MAC control element.

According to the above embodiment, when there exists a sidelink logical channel and a sidelink MAC CE to be transmitted for the destination terminal equipment and the sidelink logical channel and the sidelink MAC CE have identical priorities, the corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences.

In some embodiments, the logical channel may be a logical channel having data to be transmitted and/or a logical channel with a Bj value greater than zero and/or a logical channel satisfying logical channel priority processing mapping constraints, the MAC CE may be a triggered or generated or to-be-generated MAC CE, such as a CSI reporting MAC CE; however, this embodiment is not limited thereto; and the priority is a configured logical channel priority or a priority of the MAC CE, that is, the priority of the logical channel is a logical channel priority configured by the network device, the lower a value of the priority, the higher the priority, which is usually 1-8, and the priority of the MAC CE may be predefined or pre-configured, such as 1.

In some embodiments, priorities of an LCH and an MAC CE with identical priorities are highest priorities, and a sidelink logical channel and a sidelink MAC CE with identical priorities belong to the same or different destination terminal equipments. As shown in FIG. 12, the highest priority is 1, which are LCH2 and MAC CE1 to which a destination terminal equipment 1 corresponds and MAC CE2 to which destination terminal equipment 2 corresponds, respectively. MAC CE1 and LCH2 belong to the same destination terminal equipment, and LCH2 and MAC CE2 belong to different destination terminal equipments.

In some embodiments, the first selecting unit 1401 includes: a first selecting module (not shown) configured to, when the destination terminal equipments have other sidelink logical channel and/or sidelink MAC control element to be transmitted than the sidelink logical channel and the sidelink MAC control element having identical priorities, select a destination terminal equipment according to an descending order of priorities of the other sidelink logical channel and/or sidelink MAC control element, including when the sidelink logical channel and the sidelink MAC control element having identical priorities belong to identical destination terminal equipment, selecting the identical destination terminal equipment, and when the sidelink logical channel and the sidelink MAC control element having identical priorities belong to different destination terminal equipments, ranking the other sidelink logical channel and/or sidelink MAC control element to be transmitted in an descending order, and selecting therefrom a destination terminal equipment to which a sidelink logical channel and/or a sidelink MAC control element having a higher priority belong(s).

In some embodiments, the first selecting unit 1401 includes: a second selecting module (not shown) configured to select a destination terminal equipment according to the remaining delay of all sidelink logical channels and the sidelink MAC control elements to be transmitted, including selecting a destination terminal equipment to which a sidelink logical channel or a sidelink MAC control element having s shortest remaining delay or a remaining delay less than a first threshold belongs.

In some embodiments, the first selecting unit 1401 includes: a third selecting module (not shown) configured to select a destination terminal equipment according to the buffer size of the sidelink logical channel, including selecting the destination terminal equipment to which the sidelink logical channel belongs when the buffer size of the sidelink logical channel is greater than or equal to a second threshold, and selecting the destination terminal equipment to which the sidelink MAC control element belongs when the buffer size of the sidelink logical channel is less than the second threshold. When at least two destination terminal equipments have sidelink MAC CEs to be transmitted, the third selecting module determines to select the destination terminal equipment according to implementation of the terminal equipment, or the third selecting module selects the destination terminal equipment from destination terminal equipments different from destination terminal equipment to which the logical channel belongs according to the implementation of the terminal equipment.

In some embodiments, the first selecting unit 1401 includes: a fourth selecting module (not shown) configured to select a destination terminal equipment according to the number of times of previously selecting a sidelink logical channel and a sidelink MAC control element, including when the sidelink logical channel is previously selected, selecting the destination terminal equipment to which the sidelink MAC control element belongs, and when the sidelink MAC control element is previously selected, selecting the destination terminal equipment to which the sidelink MAC control element belongs. When there exist as least two destination terminal equipments having sidelink MAC control elements to be transmitted, the fourth selecting module determines to select the destination terminal equipment according to terminal equipment implementation, or the fourth selecting module determines to select the destination terminal equipment according to terminal equipment implementation from destination terminal equipments different from the destination terminal equipment to which the previously selected sidelink logical channel belongs. When there exist as least two destination terminal equipments having sidelink logical channel to be transmitted, the fourth selecting module determines to select the destination terminal equipment according to terminal equipment implementation, or the fourth selecting module determines to select the destination terminal equipment according to terminal equipment implementation from destination terminal equipments different from the destination terminal equipment to which the previously selected sidelink MAC control element belongs

In some embodiments, after the destination terminal equipment is determined, the second selecting unit 1402 selects the sidelink logical channel and/or the sidelink MAC CE belonging to the destination terminal equipment, for example, it may select a logical channel with data waiting for being transmitted and/or a logical channel satisfying logical channel mapping constraints. And the allocating unit 1403 allocates sidelink resources for the sidelink logical channel and/or the sidelink MAC CE, such as allocating the sidelink resources according to the logical channel priority and/or the priority of the MAC CE in a descending order, and the transmitting terminal equipment may transmit the LCH and/or the MAC CE by using the allocated sidelink resource.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the sidelink transmission apparatus 1400 may further include other components or modules, and reference may be made to the related techniques for specific contents of these components or modules.

Furthermore, for the sake of simplicity, connection relationships between the components or modules or signal profiles thereof are only illustrated in FIG. 14. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that when there is a sidelink logical channel and a sidelink MAC CE to be transmitted for the destination terminal equipment and the sidelink logical channel and the sidelink MAC CE have identical priorities, a corresponding destination terminal equipment is selected according to regulations, which may prevent upper-layer data from being unable to be transmitted due to that the sidelink MAC CE occupies the sidelink resources for a long time, or may prevent the channel measurement results from being unable to be reported due to that the sidelink logical channel occupies the radio resources for a long time, thereby ensuring user experiences.

In the existing techniques, when the sidelink control information indicates the receiving terminal equipment to perform hybrid automatic repeat request (HARM) feedback or perform first type of groupcast communication, the MAC layer of the transmitting terminal equipment will consider whether the receiving terminal equipment is within its communication range, so as to determine whether to instruct the physical layer to generate feedback to data in a transport block. It was found by the inventor that the current MAC layer does not consider whether data is correctly decoded, but directly instructs the physical layer to generate feedback. And the physical layer deems that the MAC layer will instruct the physical layer itself not to transmit feedback, hence, it is not determined whether to transmit feedback according to whether the data is correctly decoded or not, which will increase signaling overhead of the feedback and lead to waste of radio resources. In the embodiment of this disclosure, the terminal equipment determines whether to generate or transmit feedback according to whether the data is correctly decoded, thereby lowering signaling overhead of the feedback and saving radio resources, which shall be described below with reference to embodiments of the seventh to eighth aspects.

### Embodiment of the Seventh Aspect

The embodiment of this disclosure provides an information feedback method, which shall be described from a first terminal equipment (such as a receiving terminal equipment) side. FIG. 15 is a schematic diagram of the information feedback method of the embodiment of this disclosure.

As shown in FIG. 15, the method includes:

1501: the first terminal equipment receives sidelink control information, the sidelink control information being used to indicate the first terminal equipment to perform hybrid automatic repeat request (HARQ) feedback or a first type of groupcast communication;

1502: the first terminal equipment receives sidelink data transmitted by a second terminal equipment, and performs decoding; and

1503: the first terminal equipment generates HARQ feedback and transmits the generated HARQ feedback to the second terminal equipment when the first terminal equipment is within a communication range of the second terminal equipment and the data is not correctly decoded.

According to the above embodiment, the terminal equipment determines whether to generate or transmit the feedback with reference to whether the data is correctly decoded. Hence, signaling overhead of the feedback may be lowered, and radio resources may be saved.

It should be noted that FIG. 15 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 15.

In some embodiments, the first terminal equipment receives sidelink control information transmitted by the second terminal equipment via a physical sidelink control channel (PSCCH), the sidelink control information being used to indicate the first terminal equipment to perform HARQ feedback for the received physical sidelink shared channel (PSSCH). For example, the SCI may include a 1-bit HARQ feedback indication field, such as 1 bit, and when the bit is set to be 1, it indicates the first terminal equipment to perform HARQ feedback for data in the received PSSCH, and when the bit is set to be 0, it indicates the first terminal equipment not need to perform HARQ feedback for the data in the received PSSCH.

In some embodiments, the first terminal equipment receives the sidelink control information transmitted by the second terminal equipment via the physical sidelink control channel (PSCCH), the sidelink control information being used to indicate the first terminal equipment to perform first type of groupcast communication. For example, the SCI may contain a groupcast destination terminal equipment identifier (destination ID), and the first terminal equipment determines whether to perform the first type of groupcast communication according to the destination ID, or the SCI may contain location information and/or communication range of the second terminal equipment, and the first terminal equipment determines whether to perform the first type of groupcast communication according to whether the location information and/or the communication range of the second terminal equipment is present in the SCI, and when it/they is(are) present, the first terminal equipment determines to perform the first type of groupcast communication.

In some embodiments, at the physical layer, the first terminal equipment receives and decodes the sidelink data transmitted by the second terminal equipment. The physical layer may determine whether to generate HARQ feedback (HARQ-ACK information bits) and contents of HARQ feedback (HARQ-ACK information bits) according to the SCI. For the HARQ-ACK information bits, if the terminal equipment successfully decodes a transport block carried by the PSSCH channel, it generates positive acknowledgement (ACK), and if the terminal equipment does not correctly decode the transport block carried by the PSSCH channel, it generates negative acknowledgement (NACK). And the first terminal equipment reports the HARQ-ACK information bits to a transmitter end (the second terminal equipment) in a physical sidelink feedback channel (PSFCH) channel, that is, performing HARQ feedback.

In some embodiments, the second terminal equipment indicates a location of the second terminal equipment (such as a geographical zone identifier (zone id)) and a required communication range via the SCI. After receiving the SCI, the first terminal equipment determines whether a distance between the first terminal equipment and the second terminal equipment is less than or equal to the required communication range indicated in the SCI according to the location of the first terminal equipment and the location of the second terminal equipment indicated in the SCI, thereby determining whether the first terminal equipment is within the communication range of the second terminal equipment.

In some embodiments, in addition to a factor of the communication range, the first terminal equipment also needs to consider whether the data is correctly decoded, and the first terminal equipment will transmit HARQ feedback to the second terminal equipment only when the first terminal equipment is within the communication range and the data is not decoded correctly.

In some embodiments, the method further includes: receiving, by the first terminal equipment at an MAC layer, a decoding result transmitted by a physical layer; and when the first terminal equipment is within the communication range of the second terminal equipment and the physical layer does not correctly decode, the MAC layer of the first terminal equipment instructs the physical layer to generate HARQ feedback, the HARQ feedback being NACK. For data of a current transport block, a decoding result of the physical layer received by the MAC layer is ACK or NACK; at the MAC layer, the first terminal equipment determines whether to instruct the physical layer to generate HARQ feedback according to the decoding result and the communication range, and when the received decoding result is NACK and the first terminal equipment is within the communication range of the second terminal equipment, it instructs the physical layer to generate acknowledgement information, i.e. NACK, for the data of the current transport block, and the physical layer generates the HARQ feedback, and transmits the NACK to the second terminal equipment.

In some embodiments, the method further includes: receiving, by the first terminal equipment at an MAC layer, a decoding result transmitted by a physical layer; and when the first terminal equipment is within the communication range of the second terminal equipment and the physical layer correctly decodes, the MAC layer of the first terminal equipment instructs the physical layer not to generate HARQ feedback, or the MAC layer of the first terminal equipment does not instruct the physical layer to generate HARQ feedback. For the data of the current transport block, the decoding result of the physical layer received by the MAC layer is ACK or NACK, and the first terminal device determines whether to instruct the physical layer to generate HARQ feedback at the MAC layer according to the decoding result and the communication range, and when the received decoding result is ACK and the first terminal device is within the communication range of the second terminal equipment, it instructs the physical layer not to generate an acknowledgment message for the data of current transport block or does not instruct the physical layer to generate an acknowledgment message.

In some embodiments, the method further includes: determining the decoding result by the first terminal equipment at the MAC layer; and when the first terminal equipment is within the communication range of the second terminal equipment and a determination result is that the data is not correctly decoded, the MAC layer of the first terminal equipment instructs the physical layer to generate HARQ feedback, the HARQ feedback being NACK. For the data of the current transport block, the MAC layer determines that the decoding result is ACK or NACK, and according to the decoding result and the communication range, the first terminal equipment determines at the MAC layer whether to instruct the physical layer to generate HARQ feedback, when the decoding result is NACK and the first terminal equipment is within the communication range of the second terminal equipment, it instruct the physical layer to generate an acknowledgment message, i.e. NACK, for the data of the current transport block, and the physical layer generates the HARQ feedback, and transmits the NACK to the second terminal.

In some embodiments, the method further includes: determining whether to instruct the physical layer to generate HARQ feedback by the first terminal equipment at the MAC layer according to the communication range; when the first terminal equipment is within the communication range of the second terminal equipment, instructing the physical layer to generate HARQ feedback by the MAC layer of the first terminal equipment, and generating the HARQ feedback by the physical layer; and when the first terminal equipment does not decode correctly at the physical layer, transmitting the generated HARQ feedback by the physical layer of the first terminal equipment, when the first terminal equipment decodes correctly at the physical layer, not transmitting the HARQ feedback by the physical layer of the first terminal equipment, or instructing the physical layer to generate HARQ feedback by the MAC layer of the first terminal equipment, and when the physical layer decodes correctly, not generating the HARQ feedback by the physical layer of the first terminal equipment. For the data of the current transport block, when the MAC layer of the first terminal equipment instructs the physical layer to generate HARQ feedback, the physical layer generates the HARQ feedback, and determines whether to transmit the generated HARQ feedback according to a decoding result. When its decoding result is NACK, the physical layer transmits the NACK to the second terminal equipment, or when the decoding result is ACK, the physical layer does not transmit the ACK, or when the MAC layer of the first terminal equipment instructs the physical layer to generate HARQ feedback, the physical layer does not generate the HARQ feedback when the decoding result is NACK.

In some embodiments, in addition to the factors of the communication range and whether the data is correctly decoded, the first terminal equipment needs also to consider whether a layer-1 identifier indicated in the SCI is consistent with a layer-2 identifier, that is, the method further includes: when the first terminal equipment is within the communication range of the second terminal equipment and does not decode correctly, when the first terminal equipment determines at the MAC layer that a layer-1 destination terminal equipment (destination ID) indicated in the SCI is equal to lower 16 bits of a layer-2 ID (such as a source layer-2 ID or a destination layer-2 ID) of first terminal equipment, at the MAC layer, instructing the physical layer to generate HARQ feedback, and transmitting the generated HARQ feedback to the second terminal equipment.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment determines whether to generate or transmit feedback according to whether the data is correctly decoded, thereby lowering signaling overhead of the feedback and saving radio resources.

### Embodiment of the Eighth Aspect

The embodiment of this disclosure provides an information feedback apparatus. The apparatus may be, for example, a terminal equipment (such as the above-described terminal equipment), or one or some components or assemblies configured in a terminal equipment, with contents identical to those in the embodiment of the seventh aspect being not going to be described herein any further.

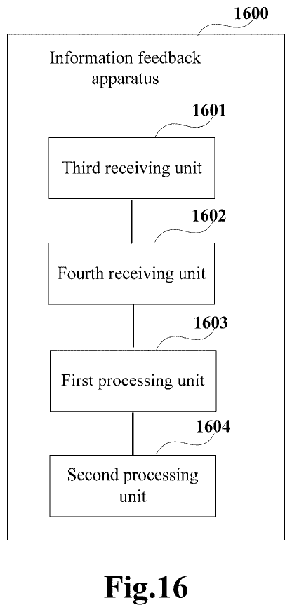

FIG. 16 is a schematic diagram of the information feedback apparatus of the embodiment of this disclosure. In some embodiments, it is applicable to a first terminal equipment side, as shown in FIG. 16, an information feedback apparatus 1600 includes:

a third receiving unit 1601 configured to receive sidelink control information, the sidelink control information being used to indicate the terminal equipment to perform hybrid automatic repeat request (HARQ) feedback or a first type of groupcast communication;

a fourth receiving unit 1602 configured to receive sidelink data transmitted by a second terminal equipment;

a first processing unit 1603 configured to perform decoding on the received sidelink data; and

a second processing unit 1604 configured to generate HARQ feedback and transmit the generated HARQ feedback to the second terminal equipment when the first terminal equipment is within a communication range of the second terminal equipment and the data is not correctly decoded.

According to the above embodiment, the terminal equipment determines whether to generate or transmit feedback according to whether the data is correctly decoded, thereby lowering signaling overhead of the feedback and saving radio resources.

In some embodiments, the third receiving unit 1601 receives sidelink control information transmitted by the second terminal equipment via a physical sidelink control channel (PSCCH), the sidelink control information being used to indicate the first terminal equipment to perform HARQ feedback for the received physical sidelink shared channel (PSSCH). For example, the SCI may include a 1-bit HARQ feedback indication field, such as 1 bit, and when the bit is set to be 1, it indicates the first terminal equipment to perform HARQ feedback for data in the received PSSCH, and when the bit is set to be 0, it indicates the first terminal equipment not need to perform HARQ feedback for the data in the received PSSCH.

In some embodiments, the first terminal equipment receives the sidelink control information transmitted by the second terminal equipment via the physical sidelink control channel (PSCCH), the sidelink control information being used to indicate the first terminal equipment to perform first type of groupcast communication. For example, the SCI may contain a groupcast destination terminal equipment identifier (destination ID), and the first terminal equipment determines whether to perform the first type of groupcast communication according to the destination ID, or the SCI may contain location information and/or communication range of the second terminal equipment, and the first terminal equipment determines whether to perform the first type of groupcast communication according to whether the location information and/or the communication range of the second terminal equipment occurs in the SCI, and when it/they occur(s), the first terminal equipment determines to perform the first type of groupcast communication.

In some embodiments, at the physical layer, the fourth receiving unit 1602 receives the sidelink data transmitted by the second terminal equipment, and the first processing unit 1603 performs decoding. The first processing unit 1603 may determine whether to generate HARQ feedback (HARQ-ACK information bits) and contents of HARQ feedback (HARQ-ACK information bits) according to the SCI. For the HARQ-ACK information bits, if the terminal equipment successfully decodes a transport block carried by the PSSCH channel, it generates positive acknowledgement (ACK), and if the terminal equipment does not correctly decode the transport block carried by the PSSCH channel, it generates negative acknowledgement (NACK). And the second processing unit 1604 reports the HARQ-ACK information bits to a transmitter end (the second terminal equipment) in a physical sidelink feedback channel (PSFCH) channel, that is, performing HARQ feedback.

In some embodiments, the second terminal equipment indicates a location of the second terminal equipment (such as a geographical zone identifier (zone id)) and a required communication range via the SCI. After the third receiving unit 1601 receives the SCI, the second processing unit 1604 determines whether a distance between the first terminal equipment and the second terminal equipment is less than or equal to the required communication range indicated in the SCI according to the location of the first terminal equipment and the location of the second terminal equipment indicated in the SCI, thereby determining whether the first terminal equipment is within the communication range of the second terminal equipment. In addition to a factor of the communication range, the second processing unit 1604 also needs to consider whether the data is correctly decoded, and transmits HARQ feedback to the second terminal equipment only when the first terminal equipment is within the communication range and does not decode correctly.

In some embodiments, the apparatus may further include (not shown):

a fifth receiving unit configured to receive, at an MAC layer, a decoding result transmitted by a physical layer.

And the second processing unit 1604 includes (not shown):

a first instructing module configured to, when the first terminal equipment is within the communication range of the second terminal equipment and the physical layer does not correctly decode, at the MAC layer, instruct the physical layer to generate HARQ feedback;

a first generating module configured to generate the HARQ feedback at the physical layer; and a first transmitting module configured to transmit the HARQ feedback at the physical layer to the second terminal equipment.

When the first terminal equipment is within the communication range of the second terminal equipment and the physical layer decodes correctly, at the MAC layer, the first instructing module instructs the physical layer not to generate HARQ feedback, or, at the MAC layer, the first instructing module does not instruct the physical layer to generate HARQ feedback.

In some embodiments, the apparatus may further include (not shown):

a first determining unit configured to, at the MAC layer, determine according to the communication range whether to instruct the physical layer to generate HARQ feedback.

And the second processing unit 1604 includes (not shown):

a second instructing module configured to, when the first terminal equipment is within the communication range of the second terminal equipment, at the MAC layer, instruct the physical layer to generate HARQ feedback;

a second generating module configured to generate the HARQ feedback at the physical layer; and

a second transmitting module configured to transmit the generated HARQ feedback from the physical layer to the second terminal equipment when the first terminal equipment does not decode correctly at the physical layer.

When the first terminal equipment decodes correctly at the physical layer, the second transmitting module does not transmit the HARQ feedback, or at the MAC layer, the second instructing module instructs the physical layer to generate the HARQ feedback, and when the physical layer decodes correctly, the second generating module does not generate the HARQ feedback at the physical layer. For data of a current transport block, when the MAC layer of the first terminal equipment instructs the physical layer to generate HARQ feedback, the physical layer generates the HARQ feedback, and determines whether to transmit the generated HARQ feedback according to the decoding result. When its decoding result is NACK, the physical layer transmits the NACK to the second terminal equipment, or when the decoding result is ACK, the physical layer does not transmit the ACK, or when the MAC layer of the first terminal equipment instructs the physical layer to generate HARQ feedback, the physical layer does not generate the HARQ feedback when the decoding result is NACK.

In some embodiments, the apparatus may further include (not shown):

a second determining unit configured to determine a decoding result at the MAC layer.

And the second processing unit 1604 includes:

a third instructing module configured to, when the first terminal equipment is within the communication range of the second terminal equipment and a determination result of the second determining unit is that the data is not correctly decoded, at the MAC layer, instruct the physical layer to generate HARQ feedback;

a third generating module configured to generate the HARQ feedback at the physical layer; and

a third transmitting module configured to transmit the HARQ feedback to the second terminal equipment at the physical layer.

In some embodiments, in addition to the factors of the communication range and whether the data is correctly decoded, the first terminal equipment needs also to consider whether a layer-1 identifier indicated in the SCI is consistent with a layer-2 identifier, and the apparatus may further include (not shown):

a third determining unit configured to, when the first terminal equipment is within the communication range of the second terminal equipment and does not decode correctly, at the MAC layer, determine whether a layer-1 destination terminal equipment indicated in the SCI is equal to lower 16 bits of a layer-2 ID of first terminal equipment, when a determination result of the third determining unit is yes, at the MAC layer, the physical layer is instructed to generate HARQ feedback, and the generated HARQ feedback is transmitted to the second terminal equipment.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information feedback apparatus 1600 may further include other components or modules, and reference may be made to the related techniques for specific contents of these components or modules.

Furthermore, for the sake of simplicity, connection relationships between the components or modules or signal profiles thereof are only illustrated in FIG. 16. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the terminal equipment determines whether to generate or transmit feedback according to whether the data is correctly decoded, thereby lowering signaling overhead of the feedback and saving radio resources.

### Embodiment of a Ninth Aspect

The embodiment of this disclosure provides a communication system, and reference may be made to FIG. 1, with contents identical to those in the embodiments of the first to the eighth aspects being not going to be described herein any further.

The embodiment of this disclosure further provides a terminal equipment; however, this disclosure is not limited thereto, and it may also be another equipment.

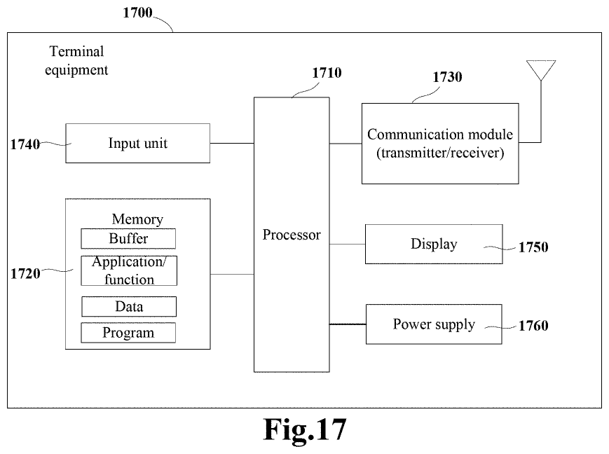

FIG. 17 is a schematic diagram of the terminal equipment of the embodiment of this disclosure. As shown in FIG. 17, a terminal equipment 1700 may include a processor 1710 and a memory 1720, the memory 1720 storing data and a program and being coupled to the processor 1710. It should be noted that this figure is illustrative only, and other types of structures may also be used, so as to supplement or replace this structure and achieve a telecommunications function or other functions.

For example, the processor 1710 may be configured to execute a program to carry out the sidelink transmission method as described in the embodiment of the first aspect. For example, the processor 1710 may be configured to perform the following control: receiving sidelink control information at a physical layer (PHY), the sidelink control information being used to trigger report of sidelink channel state information; generating sidelink channel state information at the physical layer; and transmitting the sidelink control information and the sidelink channel state information from the physical layer to a media access control (MAC) layer.

For example, the processor 1710 may be configured to execute a program to carry out the sidelink transmission method as described in the embodiment of the second aspect. For example, the processor 1710 may be configured to perform the following control: receiving sidelink control information at a media access control (MAC) layer, the sidelink control information being used to trigger sidelink channel state information reporting; and generating a sidelink channel state information reporting MAC control element in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer. For example, the processor 1710 may be configured to execute a program to carry out the sidelink transmission method as described in the embodiment of the fifth aspect. For example, the processor 1710 may be configured to perform the following control: when there exist a sidelink logical channel and a sidelink MAC control element to be transmitted for destination terminal equipments and the sidelink logical channel and the sidelink MAC control element have identical priorities, selecting a destination terminal equipment to which the sidelink logical channel belongs, or selecting a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, selecting a destination terminal equipment according to an descending order of priorities; or selecting a destination terminal equipment according to remaining delay of all sidelink logical channels and the sidelink MAC control elements to be transmitted; or selecting a destination terminal equipment according to a buffer size of a sidelink logical channel; or selecting a destination terminal equipment according to the number of times of previously selecting a sidelink logical channel and a sidelink MAC control element; selecting a sidelink logical channel and/or the sidelink MAC control element, the selected sidelink logical channel and/or sidelink MAC control element corresponding to the selected destination terminal equipment; and allocating a sidelink resource for the sidelink logical channel and/or sidelink MAC control element.

For example, the processor 1710 may be configured to execute a program to carry out the information feedback method as described in the embodiment of the seventh aspect. For example, the processor 1710 may be configured to perform the following control: receiving sidelink control information, the sidelink control information being used to indicate the terminal equipment to perform hybrid automatic repeat request (HARQ) feedback or a first type of groupcast communication; receiving sidelink data transmitted by a second terminal equipment, and performing decoding on the received sidelink data; and generating HARQ feedback and transmitting the generated HARQ feedback back to the second terminal equipment when the first terminal equipment is within a communication range of the second terminal equipment and the data is not correctly decoded.

As shown in FIG. 17, the terminal equipment 1700 may further include a communication module 1730, an input unit 1740, a display 1750, and a power supply 1760; wherein functions of the above components are similar to those in the related art, which shall not be described herein any further. It should be noted that the terminal equipment 1700 does not necessarily include all the parts shown in FIG. 17, and the above components are not necessary. Furthermore, the terminal equipment 1700 may include parts not shown in FIG. 17, and the related art may be referred to.

An embodiment of this disclosure provides a computer readable program, which, when executed in a terminal equipment, will cause the terminal equipment to carry out the sidelink transmission methods as described in the embodiments of the first, second and fifth aspects.

An embodiment of this disclosure provides a computer storage medium, including a computer readable program, which will cause a terminal equipment to carry out the sidelink transmission methods as described in the embodiments of the first, second and fifth aspects. The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the principle of the present invention, and such variants and modifications fall within the scope of the present invention. As to implementations containing the above embodiments, following supplements are further disclosed.

Supplement 1. A sidelink transmission apparatus, applicable to a terminal equipment side, the apparatus including:

a first receiving unit configured to receive sidelink control information at a physical layer (PHY), the sidelink control information being used to trigger report of sidelink channel state information;

a first generating unit configured to generate sidelink channel state information at the physical layer; and

a first transmitting unit configured to transmit the sidelink control information and the sidelink channel state information from the physical layer to a media access control (MAC) layer.

Supplement 2. The apparatus according to supplement 1, wherein the apparatus further includes:

a second generating unit configured to generate a sidelink channel state information reporting MAC control element in a case where the sidelink control information and the sidelink channel state information are received at the media access control layer and the media access control layer has a sidelink resource allocated for new transmission; and a reporting unit configured to report the sidelink channel state information.

Supplement 3. The apparatus according to supplement 1 or 2, wherein the sidelink channel state information reporting MAC control element includes the sidelink channel state information.

Supplement 4. The apparatus according to supplement 1 or 2, wherein the sidelink channel state information includes a channel quality indicator and a rank indicator.

Supplement 5. A sidelink transmission apparatus, applicable to a terminal equipment side, the apparatus including:

a second receiving unit configured to receive sidelink control information at a media access control (MAC) layer, the sidelink control information being used to trigger sidelink channel state information reporting; and

a third generating unit configured to generate a sidelink channel state information reporting MAC control element in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer.

Supplement 6. The apparatus according to supplement 5, wherein the apparatus further includes:

an acquiring unit configured to obtain the sidelink channel state information by the media access control layer from the physical layer.

Supplement 7. The apparatus according to supplement 5 or 6, wherein the sidelink channel state information reporting MAC control element includes the sidelink channel state information.

Supplement 8. The apparatus according to supplement 5 or 6, wherein the sidelink channel state information includes a channel quality indicator and a rank indicator.

Supplement 9. A sidelink transmission apparatus, applicable to a transmitting terminal equipment, the apparatus including:

a first selecting unit configured to, when there exist a sidelink logical channel and a sidelink MAC control element to be transmitted for destination terminal equipments and the sidelink logical channel and the sidelink MAC control element have identical priorities, select a destination terminal equipment to which the sidelink logical channel belongs, or select a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, select a destination terminal equipment according to an descending order of priorities; or select a destination terminal equipment according to remaining latencies of all sidelink logical channels and the sidelink MAC control elements to be transmitted; or select a destination terminal equipment according to a buffer size of a sidelink logical channel; or select a destination terminal equipment according to the number of times of previously selecting a sidelink logical channel and a sidelink MAC control element;

a second selecting unit configured to select a sidelink logical channel and/or the sidelink MAC control element, the selected sidelink logical channel and/or sidelink MAC control element corresponding to the selected destination terminal equipment; and

an allocating unit configured to allocate a sidelink resource for the sidelink logical channel and/or sidelink MAC control element.

Supplement 10. The apparatus according to supplement 9, wherein the first selecting unit includes a first selecting module configured to, when the destination terminal equipments have other sidelink logical channel and/or sidelink MAC control element to be transmitted than the sidelink logical channel and the sidelink MAC control element having identical priorities, select a destination terminal equipment according to an descending order of priorities of the other sidelink logical channel and/or sidelink MAC control element, including when the sidelink logical channel and the sidelink MAC control element having identical priorities belong to identical destination terminal equipments, selecting the identical destination terminal equipments, and when the sidelink logical channel and the sidelink MAC control element having identical priorities belong to different destination terminal equipments, ranking the other sidelink logical channels and/or sidelink MAC control elements to be transmitted in an descending order, and selecting therefrom a destination terminal equipment to which a sidelink logical channel and/or a sidelink MAC control element having a higher priority belong(s).

Supplement 11. The apparatus according to supplement 9, wherein the first selecting unit includes a second selecting module configured to select a destination terminal equipment according to the remaining latencies of all sidelink logical channels and the sidelink MAC control elements to be transmitted, including selecting a destination terminal equipment to which a sidelink logical channel or a sidelink MAC control element having s shortest remaining delay or a remaining delay less than a first threshold belongs.

Supplement 12. The apparatus according to supplement 9, wherein the first selecting unit includes a third selecting module configured to select a destination terminal equipment according to the buffer size of the sidelink logical channel, including selecting the destination terminal equipment to which the sidelink logical channel belongs when the buffer size of the sidelink logical channel is greater than or equal to a second threshold, and selecting the destination terminal equipment to which the sidelink MAC control element belongs when the buffer size of the sidelink logical channel is less than the second threshold.

Supplement 13. The apparatus according to supplement 12, wherein when there exist as least two destination terminal equipments having sidelink MAC control elements to be transmitted, the third selecting module decides a selected destination terminal equipment according to terminal equipment implementation, or the third selecting module decides a selected destination terminal equipment according to terminal equipment implementation from destination terminal equipments different from the destination terminal equipment to which the sidelink logical channel belongs.

Supplement 14. The apparatus according to supplement 9, wherein the first selecting unit includes a fourth selecting module configured to select a destination terminal equipment according to the number of times of previously selecting a sidelink logical channel and a sidelink MAC control element, including when the sidelink logical channel is previously selected, selecting the destination terminal equipment to which the sidelink MAC control element belongs, and when the sidelink MAC control element is previously selected, selecting the destination terminal equipment to which the sidelink MAC control element belongs.

Supplement 15. The apparatus according to supplement 14, wherein when there exist as least two destination terminal equipments having sidelink MAC control elements to be transmitted, the fourth selecting module decides a selected destination terminal equipment according to terminal equipment implementation, or the fourth selecting module decides a selected destination terminal equipment according to terminal equipment implementation from destination terminal equipments different from the destination terminal equipment to which the previously selected sidelink logical channel belongs.

Supplement 16. The apparatus according to supplement 14, wherein when there exist as least two destination terminal equipments having sidelink logical channels to be transmitted, the fourth selecting module decides a selected destination terminal equipment according to terminal equipment implementation, or the fourth selecting module decides a selected destination terminal equipment according to terminal equipment implementation from destination terminal equipments different from the destination terminal equipment to which the previously selected sidelink MAC control element belongs.

Supplement 17. The apparatus according to any one of supplements 9-16, wherein the sidelink logical channel and the sidelink MAC control element have identical priorities belong to identical or different destination terminal equipments.

Supplement 18. The apparatus according to any one of supplements 9-17, wherein the identical priorities are highest priorities.

Supplement 19. The apparatus according to any one of supplements 9-18, wherein the priorities are configured sidelink logical channel priorities, or sidelink MAC control element priorities.

Supplement 20. The apparatus according to any one of supplements 9-19, wherein the sidelink MAC control element is a sidelink channel state information reporting MAC control element.

Supplement 21. An information feedback apparatus, applicable to a first terminal equipment side, the apparatus including:

a third receiving unit configured to receive sidelink control information, the sidelink control information being used to indicate the terminal equipment to perform hybrid automatic repeat request (HARQ) feedback or a first type of groupcast communication;

a fourth receiving unit configured to receive sidelink data transmitted by a second terminal equipment;

a first processing unit configured to perform decoding on the received sidelink data; and

a second processing unit configured to generate HARQ feedback and transmit the generated HARQ feedback to the second terminal equipment when the first terminal equipment is within a communication range of the second terminal equipment and the data is not correctly decoded.

Supplement 22. The apparatus according to supplement 21, wherein the apparatus further includes:

a fifth receiving unit configured to receive, at an MAC layer, a decoding result transmitted by a physical layer;

and the second processing unit includes:

a first instructing module configured to, when the first terminal equipment is within the communication range of the second terminal equipment and the physical layer does not correctly decode, at the MAC layer, instruct the physical layer to generate HARQ feedback;

a first generating module configured to generate the HARQ feedback at the physical layer; and

a first transmitting module configured to transmit the HARQ feedback at the physical layer to the second terminal equipment.

Supplement 23. The apparatus according to supplement 22, wherein when the first terminal equipment is within the communication range of the second terminal equipment and the physical layer decodes correctly, at the MAC layer, the first instructing module instructs the physical layer not to generate HARQ feedback, or, at the MAC layer, the first instructing module does not instruct the physical layer to generate HARQ feedback.

Supplement 24. The apparatus according to supplement 21, wherein the apparatus further includes:

a first determining unit configured to, at the MAC layer, determine according to the communication range whether to instruct the physical layer to generate HARQ feedback;

and the second processing unit includes:

a second instructing module configured to, when the first terminal equipment is within the communication range of the second terminal equipment, at the MAC layer, instruct the physical layer to generate HARQ feedback;

a second generating module configured to generate the HARQ feedback at the physical layer; and

a second transmitting module configured to transmit the generated HARQ feedback from the physical layer to the second terminal equipment when the first terminal equipment does not decode correctly at the physical layer.

Supplement 25. The apparatus according to supplement 24, wherein when the first terminal equipment decodes correctly at the physical layer, the second transmitting module does not transmit the generated HARQ feedback to the second terminal equipment, or when the physical layer decodes correctly, the second generating module does not generate the HARQ feedback at the physical layer.

Supplement 26. The apparatus according to supplement 22, wherein the apparatus further includes:

a second determining unit configured to determine a decoding result at the MAC layer;

and the second processing unit includes:

a third instructing module configured to, when the first terminal equipment is within the communication range of the second terminal equipment and a determination result of the second determining unit is that the data is not correctly decoded, at the MAC layer, instruct the physical layer to generate HARQ feedback;

a third generating module configured to generate the HARQ feedback at the physical layer; and

a third transmitting module configured to transmit the HARQ feedback to the second terminal equipment at the physical layer.

Supplement 27. The apparatus according to supplement 22, wherein the apparatus further includes:

a third determining unit configured to, when the first terminal equipment is within the communication range of the second terminal equipment and does not decode correctly, at the MAC layer, determine whether a layer-1 destination terminal equipment indicated in the SCI is equal to lower 16 bits of a layer-2 ID of first terminal equipment,

and when a determination result of the third determining unit is yes, at the MAC layer, the second processing unit instructs the physical layer to generate HARQ feedback, and transmit the generated HARQ feedback to the second terminal equipment.

Supplement 28. The apparatus according to any one of supplements 21-27, wherein the HARQ feedback is NACK (negative acknowledgement).

Supplement 29. The apparatus according to any one of supplements 21-28, wherein at the physical layer, the third receiving unit receives the sidelink data transmitted by the second terminal equipment, and the processing unit decodes at the physical layer.

Supplement 30. A sidelink transmission method, applicable to a terminal equipment side, the method including:

receiving sidelink control information by the terminal equipment at a physical layer (PHY), the sidelink control information being used to trigger report of sidelink channel state information;

generating sidelink channel state information by the terminal equipment at the physical layer; and

transmitting the sidelink control information and the sidelink channel state information by the terminal equipment from the physical layer to a media access control (MAC) layer.

Supplement 31. The method according to supplement 30, wherein the method further includes:

generating a sidelink channel state information reporting MAC control element in a case where the sidelink control information and the sidelink channel state information are received at the media access control layer and the MAC entity has a sidelink resource allocated for new transmission, and reporting the sidelink channel state information.

Supplement 32. The method according to supplement 30 or 31, wherein the sidelink channel state information reporting MAC control element includes the sidelink channel state information.

Supplement 33. The method according to supplement 30 or 31, wherein the sidelink channel state information includes a channel quality indicator and a rank indicator.

Supplement 34. A sidelink transmission method, applicable to a terminal equipment side, the method including:

receiving sidelink control information by the terminal equipment at a media access control (MAC) layer, the sidelink control information being used to trigger sidelink channel state information reporting; and

generating a sidelink channel state information reporting MAC control element by the terminal equipment in a case where an MAC entity has a sidelink resource allocated for new transmission and has the sidelink channel state information, or in a case where an MAC entity has a sidelink resource allocated for new transmission and the sidelink resource is later than channel state information calculation delay of physical layer.

Supplement 35. The method according to supplement 34, wherein the method further includes:

obtaining the sidelink channel state information by the media access control layer of the terminal equipment from the physical layer.

Supplement 36. The method according to supplement 34 or 35, wherein the sidelink channel state information reporting MAC control element includes the sidelink channel state information.

Supplement 37. The method according to supplement 34 or 35, wherein the sidelink channel state information includes a channel quality indicator (CQI) and a rank indicator (RI).

Supplement 38. A sidelink transmission method, applicable to a transmitting terminal equipment, the method including:

when there exist a sidelink logical channel and a sidelink MAC control element to be transmitted for destination terminal equipments and the sidelink logical channel and the sidelink MAC control element have identical priorities, selecting a destination terminal equipment to which the sidelink logical channel belongs by the transmitting terminal equipment, or selecting a destination terminal equipment to which the sidelink MAC control element belongs; or when the destination terminal equipments have other sidelink logical channel and/or sidelink MAC control element to be transmitted than the sidelink logical channel and the sidelink MAC control element having identical priorities, selecting a destination terminal equipment according to an descending order of priorities; or selecting a destination terminal equipment according to remaining latencies of all sidelink logical channels and the sidelink MAC control elements to be transmitted; or selecting a destination terminal equipment according to a buffer size of a sidelink logical channel;

or selecting a destination terminal equipment according to the number of times of previously selecting a sidelink logical channel and a sidelink MAC control element;

selecting a sidelink logical channel and/or the sidelink MAC control element, the selected sidelink logical channel and/or sidelink MAC control element corresponding to the selected destination terminal equipment; and allocating a sidelink resource for the sidelink logical channel and/or sidelink MAC control element.

Supplement 39. The method according to supplement 38, wherein when the destination terminal equipments have other sidelink logical channel and/or sidelink MAC control element to be transmitted than the sidelink logical channel and the sidelink MAC control element having identical priorities, the selecting a destination terminal equipment according to an descending order of priorities includes: when the sidelink logical channel and the sidelink MAC control element having identical priorities belong to identical destination terminal equipments, selecting the identical destination terminal equipments, and when the sidelink logical channel and the sidelink MAC control element having identical priorities belong to different destination terminal equipments, ranking the other sidelink logical channels and/or sidelink MAC control elements to be transmitted in an descending order, and selecting therefrom a destination terminal equipment to which a sidelink logical channel and/or a sidelink MAC control element having a higher priority belong(s).

Supplement 40. The method according to supplement 38, wherein the selecting a destination terminal equipment according to the remaining latencies of all sidelink logical channels and the sidelink MAC control elements to be transmitted includes: selecting a destination terminal equipment to which a sidelink logical channel or a sidelink MAC control element having s shortest remaining delay or a remaining delay less than a first threshold belongs.

Supplement 41. The method according to supplement 38, wherein the selecting a destination terminal equipment according to the buffer size of the sidelink logical channel includes: selecting the destination terminal equipment to which the sidelink logical channel belongs when the buffer size of the sidelink logical channel is greater than or equal to a second threshold, and selecting the destination terminal equipment to which the sidelink MAC control element belongs when the buffer size of the sidelink logical channel is less than the second threshold.

Supplement 42. The method according to supplement 41, wherein when there exist as least two destination terminal equipments having sidelink MAC control elements to be transmitted, a selected destination terminal equipment is decided according to terminal equipment implementation, or a selected destination terminal equipment is decided according to terminal equipment implementation from destination terminal equipments different from the destination terminal equipment to which the sidelink logical channel belongs.

Supplement 43. The method according to supplement 38, wherein the selecting a destination terminal equipment according to the number of times of previously selecting a sidelink logical channel and a sidelink MAC control element includes: when the sidelink logical channel is previously selected, selecting the destination terminal equipment to which the sidelink MAC control element belongs, and when the sidelink MAC control element is previously selected, selecting the destination terminal equipment to which the sidelink MAC control element belongs.

Supplement 44. The method according to supplement 43, wherein when there exist as least two destination terminal equipments having sidelink MAC control elements to be transmitted, a selected destination terminal equipment is decided according to terminal equipment implementation, or a selected destination terminal equipment is decided according to terminal equipment implementation from destination terminal equipments different from the destination terminal equipment to which the previously selected sidelink logical channel belongs.

Supplement 45. The method according to supplement 43, wherein when there exist as least two destination terminal equipments having sidelink logical channels to be transmitted, a selected destination terminal equipment is decided according to terminal equipment implementation, or a selected destination terminal equipment is decided according to terminal equipment implementation from destination terminal equipments different from the destination terminal equipment to which the previously selected sidelink MAC control element belongs.

Supplement 46. The method according to any one of supplements 38-45, wherein the sidelink logical channel and the sidelink MAC control element have identical priorities belong to identical or different destination terminal equipments.

Supplement 47. The method according to any one of supplements 38-46, wherein the identical priorities are highest priorities.

Supplement 48. The method according to any one of supplements 38-47, wherein the priorities are configured sidelink logical channel priorities, or sidelink MAC control element priorities.

Supplement 49. The method according to any one of supplements 38-48, wherein the MAC CE is a CSI reporting MAC CE.

Supplement 50. An information feedback method, applicable to a first terminal equipment side, the method including:

receiving sidelink control information by the first terminal equipment, the sidelink control information being used to indicate the terminal equipment to perform hybrid automatic repeat request (HARQ) feedback or a first type of groupcast communication;

receiving, by the first terminal equipment, sidelink data transmitted by a second terminal equipment;

decoding the received sidelink data by the first terminal equipment; and

generating HARQ feedback and transmitting the generated HARQ feedback to the second terminal equipment when the first terminal equipment is within a communication range of the second terminal equipment and data is not correctly decoded.

Supplement 51. The method according to supplement 50, wherein the method further includes:

receiving, by the first terminal equipment at an MAC layer, a decoding result transmitted by a physical layer;

and when the first terminal equipment is within the communication range of the second terminal equipment and the physical layer does not correctly decode, at the MAC layer, the first terminal equipment instructs the physical layer to generate HARQ feedback, generates HARQ feedback at the physical layer and transmits the HARQ feedback to the second terminal equipment at the physical layer.

Supplement 52. The method according to supplement 51, wherein when the first terminal equipment is within the communication range of the second terminal equipment and the physical layer correctly decodes, at the MAC layer, the first terminal equipment instructs the physical layer not to generate HARQ feedback, or at the MAC layer, does not instruct the physical layer to generate HARQ feedback.

Supplement 53. The method according to supplement 50, wherein the method further includes:

determining by the first terminal equipment at the MAC layer according to the communication range whether to instruct the physical layer to generate HARQ feedback;

and when the first terminal equipment is within the communication range of the second terminal equipment, at the MAC layer, the first terminal equipment instructs the physical layer to generate HARQ feedback; the physical layer generates HARQ feedback; and when the physical layer does not decode correctly, the first terminal equipment transmits the generated HARQ feedback to the second terminal equipment at the physical layer.

Supplement 54. The method according to supplement 53, wherein when the physical layer correctly decodes, the first terminal equipment does not transmit the generated HARQ feedback to the second terminal equipment; or, when the physical layer correctly decodes, the first terminal equipment does not generate the HARQ feedback at the physical layer.

Supplement 55. The method according to supplement 50, wherein the method further includes:

determining the decoding result by the first terminal equipment at the MAC layer;

and when the first terminal equipment is within the communication range of the second terminal equipment and a determination result is being not correctly decoded, at the MAC layer, the first terminal equipment instructs the physical layer to generate HARQ feedback, generates the HARQ feedback at the physical layer, and transmits the HARQ feedback to the second terminal equipment at the physical layer.

Supplement 56. The method according to supplement 50, wherein the method further includes:

when the first terminal equipment is within the communication range of the second terminal equipment and data is not correctly decoded, determining by the first terminal equipment at the MAC layer whether a layer 1 destination address ID indicated in a sidelink control information (SCI) is equal to lower 16 bits of a layer 2 ID of the first terminal equipment; and when a determination result is yes, generating HARQ feedback, and transmitting the generated HARQ feedback to the second terminal equipment, by the first terminal equipment.

Supplement 57. The method according to any one of supplements 50-56, wherein the HARQ feedback is NACK (negative acknowledgement).

Supplement 58. The method according to any one of supplements 50-57, wherein at the physical layer, the first terminal equipment receives sidelink data transmitted by the second terminal equipment, and performs decoding at the physical layer.

Supplement 59. A terminal equipment, including a memory and a processor, the memory storing a computer program, and the processor being configured to execute the computer program to carry out the method as described in any one of supplements 29-58.

Supplement 60. A communication system, including at least one terminal equipment described in supplement 59.

1. An information feedback apparatus, applicable to a first terminal equipment side, the apparatus comprising:
a memory; and
a processor coupled to the memory and configured to:
receive sidelink control information, the sidelink control information being used to indicate the first terminal equipment to perform hybrid automatic repeat request (HARQ) feedback, wherein HARQ feedback information only comprises NACK;
receive sidelink data transmitted by a second terminal equipment;
decode the received sidelink data; and
generate HARQ feedback information and transmit the generated HARQ feedback information to the second terminal equipment when the first terminal equipment is within a communication range of the second terminal equipment and the sidelink data is not correctly decoded.

2. The apparatus according to claim 1, wherein the processor further configured to:
determine a decoding result at an MAC layer;
and when the first terminal equipment is within the communication range of the second terminal equipment and a determination result is being not correctly decoded, at the MAC layer, instruct a physical layer to generate HARQ feedback.

3. The apparatus according to claim 1, wherein the generated HARQ feedback information is NACK (negative acknowledgement).

4. The apparatus according to claim 1, wherein the sidelink control information comprises one bit of HARQ feedback indicator field to instruct the first terminal equipment whether or not to perform HARQ feedback.

5. The apparatus according to claim 4, wherein the value of the one bit of HARQ feedback indicator field being set to 1 indicates that the first terminal equipment performs HARQ feedback for received data.

6. The apparatus according to claim 1, wherein the sidelink control information being further used to indicate the first terminal equipment to perform groupcast communication with HARQ feedback information only comprising NACK.

7. The apparatus according to claim 6, wherein the sidelink control information further comprises location information of the second terminal equipment and/or the communication range.

8. The apparatus according to claim 7, wherein the processor further configured to perform the HARQ feedback according to the location information of the second terminal equipment and/or the communication range in the sidelink control information.

9. The apparatus according to claim 1, wherein the processor further comprises:
receive at an MAC layer, a decoding result transmitted by a physical layer;
and when the first terminal equipment is within the communication range of the second terminal equipment and the physical layer does not correctly decode, at the MAC layer, instruct the physical layer to generate HARQ feedback, generate HARQ feedback at the physical layer and transmit the HARQ feedback to the second terminal equipment at the physical layer.

10. The apparatus according to claim 9, wherein when the first terminal equipment is within the communication range of the second terminal equipment and the physical layer correctly decodes, at the MAC layer, the processor further configured to instruct the physical layer not to generate HARQ feedback, or at the MAC layer, the processor further configured not to instruct the physical layer to generate HARQ feedback.

11. The apparatus according to claim 1, wherein the processor further configured to:
determine at an MAC layer according to the communication range whether to instruct a physical layer to generate HARQ feedback;
and when the first terminal equipment is within the communication range of the second terminal equipment, at the MAC layer, instruct the physical layer to generate HARQ feedback; at the physical layer, generate HARQ feedback; and when the physical layer does not decode correctly, transmit the generated HARQ feedback to the second terminal equipment at the physical layer.

12. The apparatus according to claim 11, wherein when the physical layer correctly decodes, the processor configured not to transmit the generated HARQ feedback to the second terminal equipment; or, when the physical layer correctly decodes, the first terminal equipment does not generate the HARQ feedback at the physical layer.

13. The apparatus according to claim 1, wherein the processor further configured to:
when the first terminal equipment is within the communication range of the second terminal equipment and the sidelink data is not correctly decoded, determine at an MAC layer whether a layer 1 destination address ID indicated in a sidelink control information (SCI) is equal to lower 16 bits of a layer 2 ID of the first terminal equipment; and
when a determination result is yes, generate HARQ feedback, and transmit the generated HARQ feedback to the second terminal equipment.

14. The apparatus according to claim 1, wherein at a physical layer, the processor further configured to receive the sidelink data transmitted by the second terminal equipment, and perform decoding at the physical layer.

15. An information feedback apparatus, applicable to a second terminal equipment side, the apparatus comprising:
a memory; and
a processor coupled to the memory and configured to:
transmit sidelink control information to a first terminal equipment, the sidelink control information being used to indicate the first terminal equipment to perform hybrid automatic repeat request (HARQ) feedback, wherein HARQ feedback information only comprises NACK;
transmit sidelink data to the first terminal equipment;
receive HARQ feedback information generated and transmitted by the first terminal equipment when the first terminal equipment is within a communication range of the second terminal equipment and the sidelink data is not correctly decoded by the first terminal equipment.

16. The apparatus according to claim 15, wherein the received HARQ feedback information is NACK (negative acknowledgement).

17. The apparatus according to claim 15, wherein the sidelink control information comprises one bit of HARQ feedback indicator field to instruct the first terminal equipment whether or not to perform HARQ feedback.

18. The apparatus according to claim 17, wherein the value of the one bit of HARQ feedback indicator field being set to 1 indicates that the first terminal equipment performs HARQ feedback for received data.

19. The apparatus according to claim 15, wherein the sidelink control information being further used to indicate the first terminal equipment to perform groupcast communication with HARQ feedback information only comprising NACK.

20. The apparatus according to claim 19, wherein the sidelink control information further comprises location information of the second terminal equipment and/or the communication range.
